(19) United States
(12) Patent Application Publication
(10) Pub. No.: US 2013/0250487 A1
(43) Pub. Date: Sep. 26, 2013

(54) SWITCH BAY FOR HIGH-VOLTAGE SWITCHGEAR ASSEMBLY, AND METHOD FOR INSTALLATION THEREOF

(71) Applicant: ABB Technology AG, Zurich (CH)

(72) Inventors: Walter HOLAUS, Zurich (CH); Alexander Troeger, Dusseldorf (DE); Tobias Haas, Zurich (CH); Dieter Fuechsle, Endingen (CH)

(73) Assignee: ABB Technology AG, Zurich (CH)

(21) Appl. No.: 13/895,633

(22) Filed: May 16, 2013

Related U.S. Application Data
(63) Continuation of application No. PCT/EP2010/067593, filed on Nov. 16, 2010.

(51) Int. Cl. H02B 13/00

(52) U.S. Cl. CPC H02B 13/00
USPC 361/612; 29/622

(57) ABSTRACT

A switch bay for a high-voltage switchgear assembly includes three gas-insulated circuit breakers each for corresponding one of first, second and third current phases. The circuit breakers are arranged parallel to one another along an x direction. Three switch disconnectors are provided for a corresponding one of the first, second and third current phases. The switch disconnectors each have a corresponding isolating gap. The isolating gaps are arranged parallel to one another. A first busbar phase conductor section of the first current phase and a second busbar phase conductor section of the second current phase extend parallel to one another along a y direction, which runs transversely with respect to the x direction. A busbar connection is provided for connection of a third busbar phase conductor section of the third current phase.

### RELATED APPLICATION

This application claims priority under 35 U.S.C. §120 to PCT/EP2010067593, which was filed as an International Application on Nov. 16, 2010 designating the U.S., the entire content of which is hereby incorporated by reference in its entirety.

### FIELD

The present disclosure relates to a switch bay for a high-voltage switchgear assembly, such as a switchgear assembly having a busbar, for example. The present disclosure also relates to a switch bay having circuit breakers, switch disconnectors and busbar phase conductor sections. In addition, the present disclosure relates to a high-voltage switchgear assembly having such a switch bay, and to a method for installation of a high-voltage switchgear assembly.

### BACKGROUND INFORMATION

Switchgear assemblies play an important role for power systems which transport electrical power from the power station to the end user. Switchgear assemblies such as these include one or more busbars and switch bays, which are used to couple incoming and outgoing lines of the power systems, for example cross-country lines, switchably to the busbars, or else to couple busbars switchably to one another.

Switchgear assemblies are subdivided into different voltages to be switched. In this case, high-voltage switchgear assemblies are considered to be switchgear assemblies having a rated voltage of at least 300 kV, for example, of at least 420 kV. Gas-insulated switchgear assemblies are frequently used for high and medium voltages, in which the conductors are surrounded by an inert gas such as SF₆. For this purpose, the electrical components are arranged in a gas-tight housing (encapsulation), which defines a gas area for the inert gas.

On the basis of their encapsulation, high-voltage switchgear assemblies can be subdivided into two different types: on the one hand, one type with a three-phase-encapsulated busbar, that is to say, the phase conductors for all three current phases are accommodated in a common encapsulated gas area, and on the other hand, a type with single-phase-encapsulated busbar, that is to say, the individual phase conductors of the busbar, one for each of the generally three current phases which occur have individual encapsulation, at least in places, and are therefore separated from one another by housing sections.

The choice of the respective type of switchgear assembly (three-phase or single-phase encapsulated) is largely predetermined by the rated voltage to be switched. For example, switchgear assemblies with a single-phase-encapsulated busbar are predominantly used for a rated voltage of at least 300 kV and in particular of at least 420 kV. The single-phase encapsulation allows very effective shielding of the high voltages which occur. However, the design of single-phase-encapsulated switchgear assemblies is complex and space-consuming, since a dedicated housing must be provided for each phase conductor of the busbar. These housings also have to have a certain volume in order to allow sufficient separation of the conductors from the grounded housing parts, thus adequately reducing the risk of an electrical breakdown.

Since the energy demand is growing, particularly in economically emerging regions, it is desirable to be able to set up a switchgear assembly in as short a time as possible, in order to satisfy this demand quickly. However, particularly in the case of a high-voltage switchgear assembly with a single-phase-encapsulated busbar, this is difficult because a switchgear assembly such as this must be assembled, as described, from a large number of individual parts and must then be subjected to comprehensive functionality tests, and the construction is therefore complex and time-consuming. In addition, high-voltage switchgear assemblies such as these with a single-encapsulated busbar also have a relatively space-consuming construction, and it is desirable to reduce this space requirement as much as possible in areas where the available space is restricted, for example in the vicinity of highly populated regions. Finally, the most important requirement for a switchgear assembly is operational safety, and no compromises should be made relating to this.

### SUMMARY

An exemplary embodiment of the present disclosure provides a switch bay for a high-voltage switchgear assembly. The high-voltage switchgear assembly includes a busbar having three busbar phase conductors each respectively provided for a corresponding one of a first current phase, a second current phase and a third current phase. The exemplary switch bay includes three gas-insulated circuit breakers each respectively provided for a corresponding one of the first current phase, the second current phase and the third current phase. The circuit breakers being arranged parallel to one another along an x direction. The exemplary switch bay also includes three switch disconnectors each respectively provided for a corresponding one of the first current phase, the second current phase and the third current phase. The switch disconnectors each have a corresponding isolating gap, respectively, where the three isolating gaps are arranged parallel to one another. In addition, the exemplary switch bay includes a first busbar phase conductor section of the first current phase and a second busbar phase conductor section of the second current phase. The first and the second busbar phase conductor sections extend parallel to one another along a y direction, which runs transversely with respect to the x direction. Furthermore, the exemplary switch bay includes a busbar connection for connection of a third busbar phase conductor section of the third current phase. The first and the second busbar phase conductor sections and the busbar connection are configured to be electrically connected via the corresponding switch disconnector of the respective current phase to the circuit breaker of the respective current phase. The second busbar phase conductor section defines a boundary plane which runs in the x and y directions and contains a center of the second busbar phase conductor section. Each of the three isolating gaps is arranged at least partially on a side of the boundary plane which faces the three circuit breakers. The first busbar phase conductor section, the second busbar phase conductor section and the third busbar phase conductor section are arranged one above the other in a z direction, which runs transversely with respect to the x and y directions, after connection of the third busbar phase conductor section of the third current phase to the busbar connection of the switch bay.

An exemplary embodiment of the present disclosure provides a high-voltage switchgear assembly having the above-described switch bay.

An exemplary embodiment of the present disclosure provides a method for installation of a high-voltage switchgear assembly. The exemplary method includes providing a preassembled switch bay, such as the above-described switch bay, in a standardized transport container physically remotely from an installation location for the high-voltage switchgear assembly. The switch bay has the aforementioned first busbar phase conductor section of the first current phase, and the aforementioned second busbar phase conductor section of the second current phase. The exemplary method also includes transporting the switch bay in the transport container to the installation location for the high-voltage switchgear assembly, and connecting the third busbar phase conductor section of the third current phase to a busbar connection of the switch bay, such that the busbar phase conductor section of the third current phase has a physical height which is greater than an internal height of the transport container.

### BRIEF DESCRIPTION OF THE DRAWINGS

Additional refinements, advantages and features of the present disclosure are described in more detail below with reference to exemplary embodiments illustrated in the drawings, in which. Different individual features can also be omitted or can be combined with other features. In the drawings:

FIG. 1 shows a perspective view of a switch bay according to an exemplary embodiment of the present disclosure;

FIGS. 2a to 2c show side cross-sectional views of the switch bay shown in FIG. 1; and

FIG. 3 shows a front view of the switch bay shown in FIGS. 1 to 2c.

### DETAILED DESCRIPTION

According to an exemplary embodiment of the present disclosure, a switch bay is provided for a high-voltage switchgear assembly. The switch bay includes a busbar having in each case one busbar phase conductor for a first current phase, a second current phase and a third current phase. The switch bay in each case includes a corresponding gas-insulated circuit breaker for the first, second and third current phases, respectively, wherein the circuit breakers are arranged parallel to one another along an x direction. Furthermore, the switch bay in each case includes a corresponding switch disconnector for the first, second and third current phases, respectively, wherein the switch disconnectors each have an isolating gap, and wherein the isolating gaps are arranged parallel to one another. Furthermore, the switch bay includes a first busbar phase conductor section of the first current phase and a second busbar phase conductor section of the second current phase, wherein the first and the second busbar phase conductor sections extend parallel to one another along a y direction, which runs transversely with respect to the x direction. Furthermore, the switch bay includes a busbar connection for connection of a third busbar phase conductor section of the third current phase. The first and the second busbar phase conductor sections and the busbar connection can be electrically connected via the switch disconnector of the respective current phase to the circuit breaker of the respective current phase. The second busbar phase conductor section defines a boundary plane as that plane which runs in the x and y directions and contains a center of the second busbar phase conductor section. Each of the three isolating gaps is arranged at least partially on that side of the boundary plane which faces the three circuit breakers.

According to an exemplary embodiment of the present disclosure, a method is provided for installation of a high-voltage switchgear assembly. In this case, the activity of installation also includes, for example, the production, equipment and/or repair of a switchgear assembly such as a switchgear assembly including the above-described switch bay. The method includes the provision of a preassembled switch bay, for example, any switch bay described herein, in a standardized transport container physically remotely from an installation location for the high-voltage switchgear assembly, wherein the switch bay has a first busbar phase conductor section of the first current phase and a second busbar phase conductor section of the second current phase. In the transport state, the switch bay, and for example, busbar phase conductor sections for the first and the second of the current phases and a busbar connection for the third current phase of the switch bay, therefore has a physical height which is less than the internal height of the transport container. The method also includes the transportation of the switch bay in the transport container to the installation location for the high-voltage switchgear assembly. In a number of exemplary embodiments, the switch bay is at least partially filled with inert gas during transportation. Furthermore, the method includes the connection of a third busbar phase conductor section of the third current phase to a busbar connection of the switch bay, such that the busbar phase conductor section of the third current phase has a physical height which is greater than an internal height of the transport container.

In this case, numerical details such as two busbar phase conductor sections should in principle be understood as meaning that at least two busbar phase conductor sections are provided. It is therefore also possible to provide more than two busbar phase conductor sections, for example.

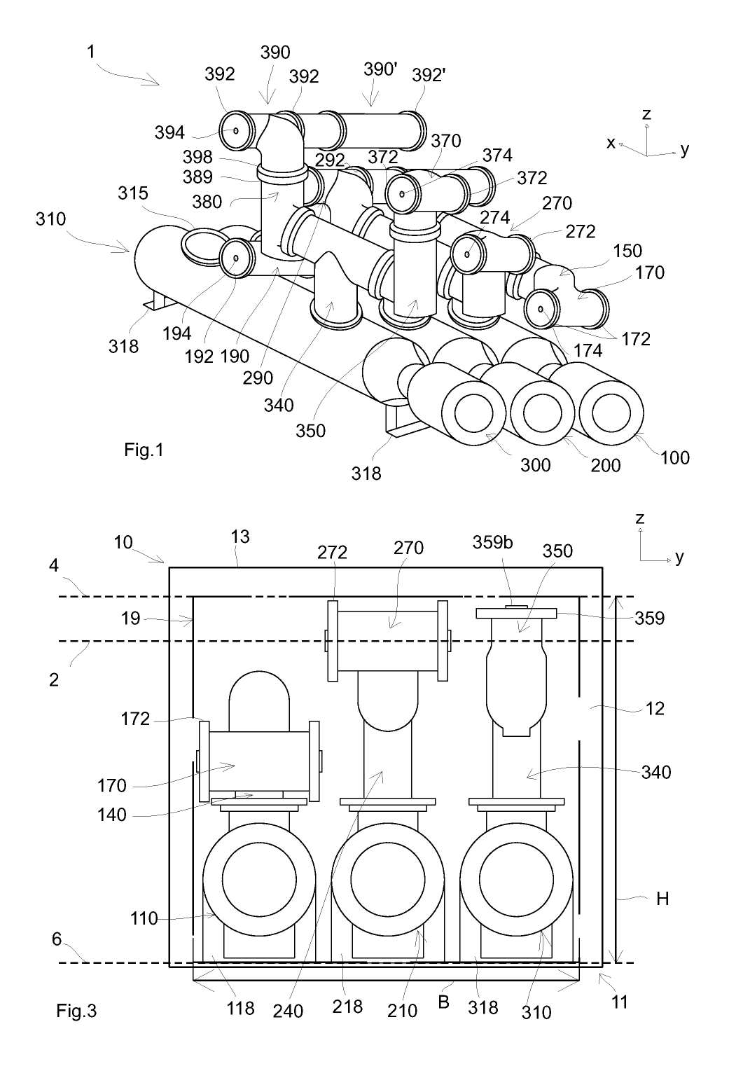

A switch bay 1 according to an exemplary embodiment of the present disclosure will be described with reference to FIG. 1. In general, a switch bay is defined herein such that it includes at least in each case one circuit breaker, one switch disconnector and one busbar phase conductor section and/or one busbar connection for connection to a busbar phase conductor for each of, for example, three current phases. In other words, for a configuration including first, second and third current phases, for example, the switch bay includes three circuit breakers, three switch disconnectors, and three busbar phase connectors and/or busbar connections for connection to a busbar phase conductor for each of a corresponding one of the three current phases, respectively. The switch bay need not yet be connected to the busbar.

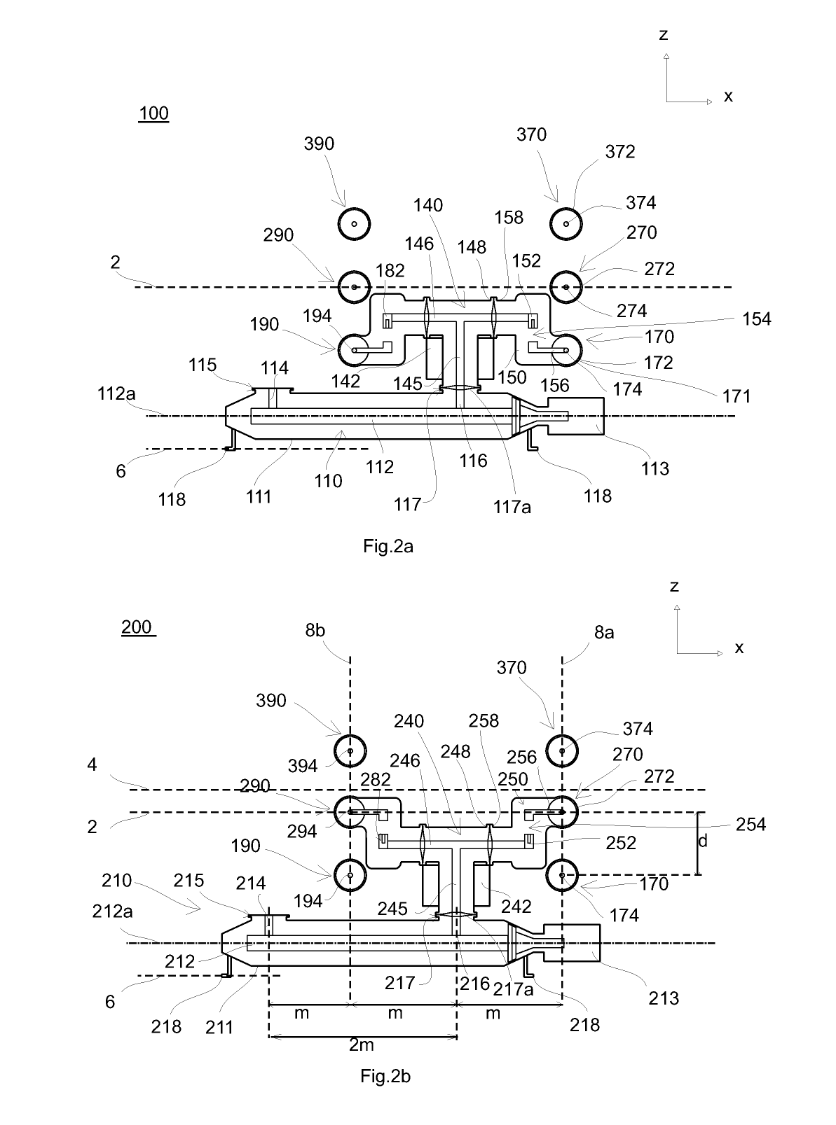

The switch bay 1 illustrated in FIG. 1 is intended to be coupled to a double busbar, with the double busbar having a first busbar and a second busbar, each having three phase conductors. These phase conductors are designed to support a respective current phase of three-phase current. The switch bay 1 includes sections of these phase conductors. For instance, respective busbar modules 170, 270 and 370, with corresponding busbar phase conductor sections 174, 274 and 374, are illustrated for the first busbar. Corresponding busbar modules 190, 290 and 390 with corresponding busbar phase conductor sections 194, 294 (see FIGS. 2b) and 394 are likewise illustrated for the second busbar. These busbar phase conductor sections are single-phase-encapsulated in the respective busbar modules. The busbar modules 170, 270, 370 as well as 190, 290 and 390 have connections 172, 272, 372, 192 (see FIGS. 2a), 292 and 392 for connection of further sections of the respective busbar phase conductor. By way of example, further sections of the busbar phase conductor are illustrated, which are connected to a number of these connections: by way of example, a module 390′ with a further phase conductor is connected to the connection 392 of the busbar module 390. The module 390′ in turn has a further connection 392′ for further modules such as these.

The switch bay 1 includes a corresponding switch bay component 100, 200 or 300 for each of the three current phases, and these switch bay components can be coupled to the busbar phase conductors of the corresponding current phase. The switch bay components 100, 200 and 300 are largely similar to one another, apart from the differences described further below. The switch bay component 300 for the third current phase will be described first of all.

The switch bay component 300 has a circuit breaker module 310 in which a circuit breaker is arranged. The circuit breaker module 310 furthermore has a first outlet 315 and a second outlet, to which a connection piece 340 is connected. The two outlets face in the same direction, that is, in a z direction. The circuit breaker module 310 furthermore has a stand frame 318.

The connection piece 340 is T-shaped and has a bottom outlet (facing in the z direction) and two mutually opposite side outlets (facing in an x direction). As described above, the connection piece 340 is connected to the corresponding outlet of the circuit breaker module 310 by means of the bottom outlet. One of the side outlets of the connection piece 340 is connected via a switch disconnector module 350 to the busbar module 370, and the other of the side outlets is connected via a switch disconnector module 380 to the busbar module 390. The circuit breaker module 310, the connection piece 340, the switch disconnector module 350 or 380 and the respective busbar module 370 or 390 have respective conductor sections, which run in their interior, and respective housing sections, with the respective housing sections defining respective gas volumes for a dielectric inert gas which surrounds the respective conductor sections. These gas volumes can be intrinsically closed or can be connected to gas volumes of adjacent modules for the inert gas, for example, via post-type insulators through which gas can pass.

The two further switch bay components 100 and 200 for the other current phases are designed in a similar manner, and the above description also applies in a corresponding manner to them. Further details relating to the three switch bay components 100, 200, 300 are described further below, for example, with reference to FIGS. 2a to 2c.

The three circuit breaker modules 110, 210, 310 and the circuit breakers provided in them are arranged parallel to one another and define an x direction as one axis of the circuit breakers (for example, the axis 112a in FIG. 2a). The circuit breakers 110, 210, 310 are separated from one another in a y direction, and are therefore arranged on a circuit breaker plane (x-y plane).

The busbar phase conductor sections 174, 274, 374 of the first busbar are also arranged parallel to one another and define a y direction as the direction parallel to which they are arranged. The indication of a direction herein does not include any absolute position indication, and is not influenced by parallel movement. In addition, the phase conductor sections 194, 294, 394 of the second busbar are arranged parallel to one another, and parallel to the y direction.

In the switch bay 1 shown in FIG. 1, the x, y and z directions are mutually perpendicular and therefore form a Cartesian coordinate system. However, this is not essential. In accordance with other exemplary embodiments, these directions can also be transverse with respect to one another, that is to say not parallel. In other exemplary embodiments, at least two, for example, all three, of the x, y and z directions include an angle of at least 60° with one another, and/or are mutually perpendicular.

As can be seen in more detail in FIGS. 2a to 2c, the busbar phase conductor sections 194, 294, 394 are arranged one above the other in the z direction. Therefore, the busbar phase conductor sections, for example, their center axes, are arranged on a busbar plane (plane 8a in FIG. 2b, that is to say a y-z plane). However, other arrangements of the phase conductor sections 194, 294, 394 are also possible. The connection pieces 140, 240 and 340 are identical to one another.

FIG. 2a shows a side cross-sectional view of the switch bay 1 on a cross-sectional plane which is at right angles to the y direction, that is to say the direction of the first phase conductor section 174, and which runs through a center of the first circuit breaker module 110. The first switch bay component 100 will be described in more detail with reference to FIG. 2a.

Analogously to the third switch bay component 300 described above, the first switch bay component 100 also has a circuit breaker module 110 with a stand frame 118. The stand frame 118 defines a base plane 6, and the switch bay 1 is arranged completely above the base plane 6. The circuit breaker module 110 has a circuit breaker 112 (illustrated schematically) and a circuit breaker housing 111, which allows gas-tight encapsulation of the circuit breaker 112. The circuit breaker 112 has an isolating gap. As used herein, an isolating gap is defined as a gap which forms an isolation gap between two ends of a switch when the switch is open, but which can be bridged by a moving switching element by closing the switch, in order to make an electrical connection between the two ends of the switch. The circuit breaker 112 can be operated by a drive module 113, which can move the moving switching element in order to open or to close the switch. The circuit breaker 112 defines a circuit breaker axis 112a, for example, as a movement axis of the moving switching element of the circuit breaker. This circuit breaker axis 112a defines the x direction.

The circuit breaker module 110 furthermore has a conductor piece 114 on one side of the isolating gap, and a further conductor piece 116 on another side of the isolating gap. The conductor piece 114 leads to a connection 115, to which further modules of the switch bay 1 can be connected, in order to be electrically connected to the conductor piece 114. Such further modules can, for example, be a switch disconnector module, a grounding switch module, a current transformer module, a voltmeter module, a cross-bay coupling module for coupling to the second busbar, a connecting module for coupling to external lines (under ground or above ground), and/or a combination of such modules. The connection 115 of the circuit breaker is directed in the z direction. The connection 115 has a connecting flange, which lies in the x-y direction. The further conductor piece 116, which is arranged on the other side of the circuit breaker 112, leads to a connection 117, which likewise faces in the z direction and has a connecting flange which runs in the x-y direction. The conductor piece 116 passes through an insulator, for example, a post-type or bulkhead insulator 117a. The insulator 117a is arranged on the same plane as the connection 117 (x-y plane).

A connection piece 140 is connected to the connection 117 of the circuit breaker module 110. The connection piece 140 is T-shaped and, in addition to the bottom outlet which is connected to the connection 117 of the circuit breaker module 110, has two mutually opposite side outlets 148. An electrical conductor with a conductor section 145 which is electrically connected to the conductor section 116 of the circuit breaker module 110 runs in the interior of the connection piece 140. The conductor piece 145 leads to a node point from which further conductor pieces 146 lead at the side to the side outlets 148 of the connection piece 140. The conductor sections 145 and 146 therefore extend like a star from the node point to the respective side outlets 148 and to the bottom outlet. The connection piece 140 can also have an optional voltmeter.

The side outlets 148 are provided with a flange which runs on the z-y plane and with a disk-type insulator which is arranged on the same plane as the flange. Furthermore, the connection piece 140 has a housing which can close the interior thereof in a gas-tight manner, in order to hold the insulating gas therein. Furthermore, the T-like connection piece 140 has an optional current transformer 142. The current transformer 142 is designed to measure a current flowing through the conductor piece 145. In accordance with an exemplary embodiment, the current transformer 142 can include magnetic coils, which can measure the current contactlessly by magnetic induction. The current transformer 142 can be arranged outside the gas volume defined by the housing.

A switch disconnector module 150 is fitted to one of the side outlets 148 of the connection piece 140. One inlet 158 of the switch disconnector module 150 is fitted to the side outlet 148 of the connection piece 140, for example, via a flange connection between the flange on the side outlet 148 and a flange which matches this on the inlet 158. The switch disconnector module 150 has a switch disconnector 152 with an isolating gap 154. One side of the isolating gaps 154 is electrically connected to the circuit breaker 112 via conductor sections, for example, 146 and 145. The other side of the isolating gap 154 is connected via a busbar connection conductor section 156 to the busbar phase conductor section 174, which will be described in more detail below. The busbar phase conductor section 174 can therefore be electrically connected to the circuit breaker 112 via the switch disconnector 152.

The switch disconnector 152 has a stationary contact piece and a moving contact piece, which can be disconnected from one another by the isolating gap 154. In alternative exemplary embodiments, the switch disconnector can also have two moving contact pieces, one for each of the two sides of the isolating gap 154. The moving contact piece can be moved in order to selectively bridge or to disconnect the isolating gap 154. The isolating gap runs in the z direction. In a number of exemplary embodiments of the present disclosure, the z direction can even be defined by the direction of the isolating gap. In the illustrated exemplary embodiment, the moving contact piece can also be moved along the z direction, or else the movement direction of the moving contact element can define the z direction.

The moving contact element of the switch disconnector 152 is arranged on that side of the isolating gap 154 which is electrically connected to the circuit breaker 112. The moving contact element of the switch disconnector 152 is physically arranged on that side of the isolating gap 154 which faces away from the circuit breaker.

The switch disconnector module 150 merges smoothly into a first busbar module 170. In other words, the switch disconnector module 150 and the first busbar module 170 are formed integrally with one another and have a common housing. The common housing defines an internal area which can be closed in a gas-tight manner and in which the switch disconnector 152 and the first busbar phase conductor section 174 are arranged. The first busbar phase conductor section 174 extends in the y direction or defines the y direction, and a housing section 171 of the first busbar module 170 extends at least in places cylindrically around the first busbar phase conductor section 174.

The circuit breaker module 110, the connection piece 140 and the switch disconnector module 150 with the first busbar module 170 therefore define a gas area, or a plurality of gas areas, which allow a connection, encapsulated by inert gas, from the circuit breaker 112 to the first busbar phase conductor section 174.

A further switch disconnector and busbar module 190 is arranged at the further side outlet of the connection piece 140 and contains a switch disconnector 182 and a further busbar phase conductor section 194. The switch disconnector and busbar module 190 is designed in a corresponding manner to the switch disconnector module 150 and busbar module 170 already described above.

Furthermore, FIG. 2a shows a second busbar module 270 and a third busbar module 370 with corresponding busbar phase conductor sections 274 and 374, respectively, for the second and third current phase, respectively, of the first busbar. Optional busbar modules 290 and 390 with corresponding busbar phase conductor sections are likewise illustrated for the second and third current phase, respectively, of the second busbar. These modules will be described in more detail further below with reference to FIGS. 2b and 2c.

A boundary plane 2 is defined as the plane which runs in the x direction (that is to say parallel to the circuit breaker axis 112a) and in the y direction (that is to say parallel to the first or second busbar phase conductor section 174, 274) and contains a center of the second busbar phase conductor section 274. The isolating gap 154 is arranged completely on the side of the circuit breaker 112 with respect to the boundary plane 2. In other exemplary embodiments of the present disclosure, the isolating gap 154 can also extend into the boundary plane 2, as a result of which it is arranged only partially on that side of the boundary plane 2 which faces the circuit breaker 112. However, the majority of the isolating gap 154 can be arranged on that side of the boundary plane 2 which faces the circuit breaker 112, for example, with at least up to 70% or even up to at least 90% of its length being arranged on that side of the boundary plane 2 which faces the circuit breaker 112. Advantages of this arrangement will be explained further below.

A second component 200 of the switch bay, which is intended for the second current phase, will be described with reference to FIG. 2b. This second component 200 is designed in a corresponding manner to the first component 100, which has been explained with reference to FIG. 2a, and the reference symbols for the component 200 that start with 2 correspond to the reference symbols of the component 100 which start with 1. With this revision to the reference symbols in mind, the description of FIG. 2a also applies to FIG. 2b, apart from the differences which can be seen in the Figure and which will be described below.

As can be seen in FIG. 1, the circuit breaker 212 is arranged parallel to the circuit breaker 112 for the first current phase, that is to say, the axis 212a likewise extends in the x direction. The circuit breaker 212 is offset in the y direction with respect to the circuit breaker 112 (see FIG. 1). Further modules of the component 200 are also correspondingly offset in the y direction with respect to the corresponding modules of the component 100. The connection piece 240, the switch disconnector module 250 and the second busbar module 270 provide a gas-insulated path for a conductor which runs from the circuit breaker 212 to the second busbar phase conductor section 274 for the second current phase, and can be disconnected only by the switch disconnector 252, for example, its isolating gap 254. The outlet 248 is arranged at the same height as the outlet 148 in FIG. 2a (that is to say at the same distance in the z direction from the base plane 6) and, correspondingly, the node point between the conductor sections 245 and 246 of the connection piece 240 is also arranged at the same height as the corresponding node point of the connection piece 140 shown in FIG. 2a. The second busbar phase conductor section 274 extends parallel to the first busbar phase conductor section 174, that is to say along the y direction.

The second busbar phase conductor section 274 is arranged offset in the z direction with respect to the first busbar phase conductor section 174. The busbar modules 170 and 270 (and 370) are therefore arranged along a busbar plane 8a which runs in the y and z directions. To be more precise, the two (three) busbar phase conductor sections 174, 274 (and 374) run on the busbar plane 8.

The height of the center of the outlet 248 of the connection piece 240 (in the z direction above the base plane 6) is located precisely centrally between the height of the first busbar module 170 and that of the second busbar module 270. This allows the switch disconnector and busbar module 250, 270 to be designed in precisely the same manner as the corresponding module 150, 170 from FIG. 2a, with the difference that the module 250, 270 from FIG. 2b is rotated through 180° about the x axis. The use of a module of the same design for the first current phase (module 150, 170 in FIG. 2a) and for the second current phase (module 250, 270 in FIG. 2b) reduces the number of different parts, and therefore allows efficient production and maintenance with fewer different parts. This also applies to the use of the same connection pieces 140, 240, 340.

Because of the rotation through 180°, the moving contact element in the switch disconnector 252 is spatially arranged on the other side of the isolating gap 254 than in the case of the switch disconnector 152. In the switch disconnector 252, the moving contact element is arranged on that side of the isolating gap 254 which faces the circuit breaker 212. More generally, the switch disconnector 154 and the switch disconnector 254 are aligned in opposite senses to one another, for example, with their moving contact pieces being arranged on different sides of the respective isolating gaps, that is to say with the moving contact piece of one of the switch disconnectors 154, 254 being arranged on the side facing the circuit breakers, and with the moving contact piece of the other of the switch disconnectors 154, 254 being arranged on the side facing away from the circuit breakers.

What has been said for the switch disconnector and busbar module 250, 270 correspondingly also applies to the module 290, which is fitted to the second side outlet of the connection piece 240, with the switch disconnector 282 and the busbar phase conductor section 294 for the second current phase of the second busbar. For the second busbar as well, the busbar modules 190, 290, 390, to be precise the busbar phase conductor sections 194, 294, 394 which are arranged in them, are arranged along a busbar plane 8b, which runs in the z-y direction.

The circuit breaker modules (in FIG. 2b: module 210; likewise also modules 110, 310) each have two power outlets 215 and 217. The centers of the outlets 215 are offset by a common distance twice m with respect to the centers of the outlets 217 in the x direction, that is to say by twice the length m indicated in FIG. 2b. In a number of exemplary embodiments of the present disclosure, this distance twice m is three times the module size of one component. For example, the module size can be 720 mm, and the distance twice m can be 2160 mm.

In a number of exemplary embodiments of the present disclosure, the busbar plane 8a is offset through a common distance m in the x direction with respect to the outlets 217, away from the outlets 215. The busbar plane 8a is therefore at a distance m from the first outlets 215 and at a distance 3m from the second outlets 217. These exemplary embodiments correspond, for example, to a variation of the switch bay shown in FIGS. 2a-2c, in which the proportions are chosen such that the three lengths illustrated as m in FIG. 2b are the same.

In a number of exemplary embodiments of the present disclosure, the busbar plane 8b is arranged centrally between the outlets 215 and 217 of the circuit breakers, in each case at a distance m. This also allows a connection to be made between the outlet 215 and the second busbar (plane 8b), for example, for a coupling module, using the same components as those fitted to the outlet 217. This central arrangement is particularly advantageous in exemplary embodiments having a double busbar.

A third component 300, which is intended for the third current phase of the switch bay will be described with reference to FIG. 2c. This third component 300 is designed in a corresponding manner to the first and second components 100, 200, which have been explained with reference to FIGS. 2a, 2b, and the reference symbols for the component 300 which start with 3 correspond to the reference symbols of the components 100 and/or 200 which start with 1 and 2. With this revision to the reference symbols in mind, the description relating to FIGS. 2a and 2b also applies to FIG. 2c, apart from the differences which can be seen in FIG. 2c and which will be described further below.

The circuit breaker module 310 is therefore designed in a corresponding manner to the circuit breaker modules 110, 210, and the circuit breaker axis 312a runs parallel to the circuit breaker axes 112a and 212a, that is to say parallel to the x direction. These axes 112a, 212a, 312a are offset with respect to one another by the same amount in the y direction (see FIG. 1). The connection piece 340 is also designed in a corresponding manner to the connection pieces 140 and 240, and its outlets 348 are at the same distance from the base plane 6 in the z direction as the outlets 248 and 148 of the corresponding connection pieces for the first and second current phases, respectively. In addition, the node point between the conductor sections 346 and 345 is at the same distance from the base plane 6 in the z direction as the corresponding node points in FIG. 2a and FIG. 2b, as a result of which these node points, for example, the outlets of all three connection pieces 140, 240, 340, lie along a straight line which runs in the y direction.

A switch disconnector module 350 is connected to the outlet 348. The switch disconnector module contains a switch disconnector 352 with an isolating gap 354. This switch disconnector is designed in a similar manner to the switch disconnector 252 in FIG. 2b, and, in particular, the moving contact piece of the switch disconnector 352 is arranged physically on the same side of the isolating gap as that in the switch disconnector 252, for example, on that side of the isolating gap 354 which faces the circuit breaker 312. Like the other isolating gaps 154 and 254, the isolating gap 354 is also arranged on the side of the circuit breaker 312 opposite the boundary plane 2.

The isolating gaps 154, 254, 354 are arranged parallel to one another. This expression parallel also includes an anti-parallel arrangement, that is to say with elements rotated through 180°. The isolating gap 354 is therefore arranged in the z direction.

In contrast to the situation with the components 100 and 200, in the component 300, the switch disconnector module 350 is not designed jointly with a busbar module. Instead of this, the switch disconnector module 350 has a busbar connection 359. The busbar connection 359 faces in the z direction. Furthermore, the busbar connection 359 is equipped with a flange which lies on the x-y plane. A conductor section 356 leads to the busbar connection 359. The conductor section 356, and therefore the busbar connection 359, can be electrically connected to the circuit breaker 312 via the switch disconnector 352.

The busbar module 370 is removably connected to the busbar connection 359, for example, via a flange connection between the flange of the busbar connection 359 and a flange, which matches this, on a corresponding connection 378 of the busbar module 370. A bulkhead insulator 359a is arranged between these flanges. The bulkhead insulator 259a is arranged on a side of the boundary plane 2 which faces away from the circuit breakers, and extends parallel to the boundary plane 2. Instead of a bulkhead insulator, it is also possible to use a post-type insulator.

The busbar module 370 is removable. In other words, the busbar connection 359 is designed for connection of a third busbar phase conductor section 374 such that a third busbar module 370 of the third current phase can be formed, in which third busbar module 370 the third busbar phase conductor section 374 is arranged.

The busbar module 370 contains the third busbar phase conductor section 374 for the third current phase, and a housing section 372 which cylindrically surrounds the busbar phase conductor section 374. Furthermore, the busbar module 370 contains a conductor section 376 which connects the busbar phase conductor section 374 to the outlet 378, and makes an electrical connection to the conductor section 356 via the outlet 378. The conductor sections 276, 256 therefore represent an electrical connection from the busbar phase conductor section 372 to the switch disconnector 352 and, via this switch disconnector, make a selectively disconnectable electrical connection to the circuit breaker 312.

The fact that the busbar module 370 is removable (by releasing the connection between the busbar connection 359 and the corresponding connection 378 of the busbar module 370) has major advantages for transportation of the switch bay. For example, this arrangement makes it possible to achieve a reduced physical height. The physical height is in this case defined as the height in the z direction or in the direction at right angles to a circuit breaker plane on which the circuit breakers are arranged. According to an exemplary embodiment, the physical height is the height of the switch bay measured from the lowest part of the switch bay, for example, from a stand frame of the circuit breaker arrangements or from the base plane 6 which is defined by this frame. Downward is in this case defined as the direction in the z direction from the boundary plane 2 to the circuit breakers.

When the third busbar module 370 is fitted, the physical height of the switch bay is predetermined by this module 370. When the section 374 is removed, the physical height in contrast corresponds to the distance in the z direction between a transport height plane 4 and the base plane 6. This reduced physical height is predetermined by the second busbar module 270 and/or by the busbar connection 359 for the third current phase. This is because, when the busbar module 370 is removed (and correspondingly the further busbar module 390), the switch bay is located completely between the base plane 6 and a transport height plane 4. All the remaining parts of the switch bay, such as the busbar modules 270, 170 and the switch disconnector module 350, are arranged between these two planes 6 and 4. When the busbar module 370 (and 390) is removed, the switch bay is in a transport state, and can be located in a standard transport container, whose internal height is not greater than the distance between the planes 6 and 4.

In addition, when the busbar module 370 (and 390) has been removed or has not been fitted, the switch disconnector modules 350 (and 380) together with the corresponding switch disconnectors 352 (and 382) for the third current phase are still fitted to the switch bay. This means that these moving parts have also already been fitted when in a transport state, in which the switch bay is located in the transport container. These moving parts therefore no longer need to be fitted at the installation location, but the assembly and pretesting can be carried out even before transportation, which provides considerable time saving for fitting and testing at the installation location.

According to an exemplary embodiment of the present disclosure, each of the three isolating gaps 154, 254, 354 is arranged at least partially below the boundary plane 2 (e.g., arranged on the side facing the three circuit breakers 112, 212, 312). As a result, this arrangement makes it possible to achieve a small physical height, as will be explained below. The busbar modules 170 and 270 also extend into an area which is located somewhat above the busbar phase conductor sections 174 and 274. By way of example, a part of the gas volume for the inert gas is also located in this area. Therefore, when the third busbar phase conductor has been removed, the switch bay also extends somewhat above the boundary plane 2 which is defined by the busbar phase conductor sections 174 and 274. The additional height corresponds at least to the distance which is required to dielectrically isolate the voltages which occur. One measure for this distance is the radius of the cylindrical housing section of the second busbar module 270.

In general, the switches 152, 252, 352 also still require a certain amount of additional space above the isolating gaps 154, 254, 354. This additional space is required for the respective switch contacts and for their dielectric isolation. In addition, the additional minimum height above the isolating gaps 154, 254, 354 which is required for this purpose corresponds, in terms of the order of magnitude, to the distance which is required for effective encapsulation of the voltages which occur.

Since the three isolating gaps 154, 254, 354 are arranged at least partially below the boundary plane 2, it is therefore possible to achieve a physical height which is not significantly further above the second busbar or the boundary plane 2 than is necessary in any case for dielectric isolation of the busbar phase conductor sections 174 and 274. This therefore allows a transport configuration which contains major moving parts of the switchgear assembly, in particular the switch disconnectors, but its physical height, or transport height plane 4, is nevertheless low.

In a number of exemplary embodiments of the present disclosure, the transport height plane 4 is separated from the boundary plane 2 by less than the distance d (distance in the z direction between the first and the second busbar phase conductor sections 174 and 274, see FIG. 2b). In other exemplary embodiments, the transport height plane 4 is separated from the boundary plane 2 by less than 80 cm.

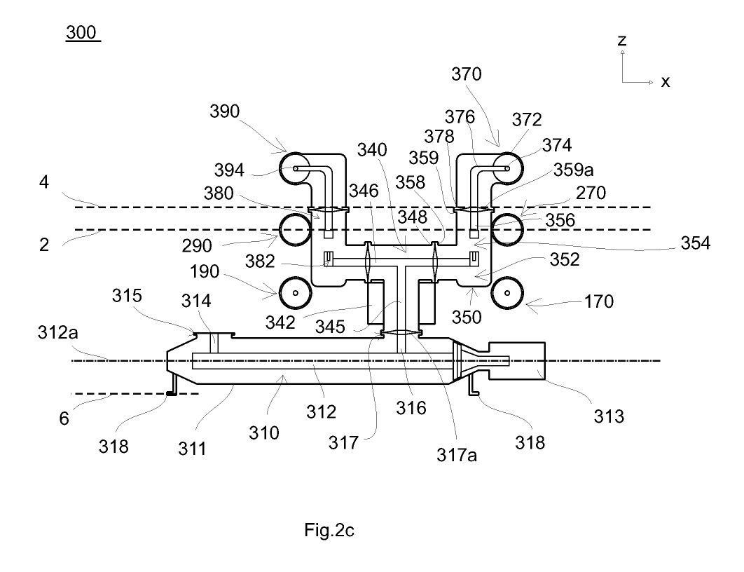

FIG. 3 illustrates a switch bay in the transport state. To be more precise, FIG. 3 shows a transport unit 10, one transport container 13 and the switch bay as illustrated in FIGS. 1 to 2c in the transport state, that is to say without the third busbar modules 370, 390. The reference symbols in FIG. 3 correspond to the reference symbols in FIGS. 1 to 2c, and reference is therefore made to the corresponding description relating to FIGS. 1 to 2c for their explanation. In addition a gas-tight attachment 359b is fitted to the connection 359 of the switch disconnector module 350 and, for example, makes it possible for an inert gas to be stored at a raised pressure in the switch disconnector module 350, without the insulator 359a, which is arranged under the attachment 359b (see FIG. 2c), bursting. The attachment 359b likewise protects the insulator 359a against contamination, and in this way prevents the possibility of contamination entering the interior of the switch bay.

The switch bay in FIG. 3 also has the drive module 113, 213, 313, which is equipped for operation of the switch disconnectors 152, 252, 352 and of the circuit breakers 112, 212, 312. In the transport state as well, the drive module 113, 213, 313 is connected to the switch disconnectors and to the circuit breakers such that they are ready to operate, that is to say all the connections which are required for operation, for example electrical and/or mechanical connections, between the drive module and the switch disconnector or circuit breaker are connected. Instead of common drive modules 113, 213, 313, it is also possible to provide separate drive modules for different switches (the circuit breaker and the switch disconnectors). Optionally, a control unit is also fitted, and is connected such that it is ready to operate, in order to control the circuit breakers and the switch disconnectors as well as other components of the switch bay.

The dimensions of the switch bay are such that the switch bay can be located in a standardized transport container 13. The physical height of the busbar connection 359, that is to say of the switch bay with the third busbar module 370 (and 390) removed, is, for example, less than 270 cm. The height of 270 cm corresponds approximately to the internal height of an exmeplary standard transport container (of the “high cube” type with an overall external height of approximately 290 cm). The physical height of the switch bay with the third busbar module 370 fitted is, in contrast, more than 270 cm.

The switch bay in FIG. 3 has been preassembled ready for transport. This means that the switch bay can be transported simply by insertion, if required, into a standard container, and the container can be transported away. In addition, this means that the parts of the switch bay which are already present are fitted to one another as is envisaged for operation of the switch bay, corresponding to the switch bay, constructed completely ready for operation, of the high-voltage switchgear assembly (with the exception of the busbar modules 370, 390).

The busbar connection 359 has no busbar phase conductor section, that is to say that it has no busbar phase conductor section, no busbar phase conductor section is connected to it, the busbar phase conductor section 370 (and 390) has been removed, and the connection 359 (and 389) has in this sense been removed.

The transport container 13 can be a standard transport container. Standard transport containers are standardized throughout the world in accordance with ISO 668, and are also referred to as freight or sea-freight containers. Transport containers are standardized for maritime use, and they can therefore easily be stacked. In particular, the following standards have been implemented in this context: on the one hand the so-called TEU container (20 foot equivalence container) with a length of approximately 6.1 m, a width of approximately 2.4 m. Further standard containers are the FEU (“forty foot equivalent unit”) container with a length of approximately 12.2 m; the forty-five foot equivalent unit container with a length of approximately 13.7 m; as well as 48-foot and even 53-foot (length: 16.15 m) containers. These containers (which are also referred to as transport containers or transportable standard containers) also all have the same width as the TEU container, that is to say approximately 2.4 m. In a so-called normal-cube embodiment, the transportable standard containers have a height of approximately 2.6 m; and in a high-cube embodiment, they have a height of approximately 2.9 m. These are external dimensions. The internal dimensions can be somewhat smaller. For instance, the internal height of the container is generally somewhat less than the overall height mentioned above, because of the wall thickness of the container, but the overall height can also be assumed to be the theoretical maximum value for the internal height. An exemplary internal height is 20 cm less than the overall height, that is to say 270 cm in the case of the high cube container. Shipment using standard containers such as these is considerably more cost-effective than shipment in tailormade containers, which cannot be transported without problems on standard container ships. It is therefore advantageous for the physical height of the switch bay when in the transport state, that is to say the distance between the base plane 6 and the transport height plane 4 which is parallel to the base plane 6, to be less than 290 cm or 270 cm (the maximum or exemplary internal height of a standard transport container), or even less than 260 or 240 cm (the maximum or exemplary internal height of a TEU container). It is furthermore advantageous for the width (on the x-y plane or in a direction at right angles to the circuit breaker axis) to be less than 2.4 m.

The transport height plane 4 is governed mainly by the height of the second busbar, that is to say by the boundary plane 2. This is because the transport height plane 4 is higher than this boundary plane 2 by at least the radius of the housing section for the second busbar, as can easily be seen in FIG. 3 and in FIG. 2b. However, this radius cannot be chosen to be indefinitely small since a certain minimum radius is required for effective shielding of the voltages which occur during operation.

It is advantageous for the switch disconnectors 152, 252, 352 (see FIGS. 2a to 2c) to also already be in the transport state for all three current phases. This is because fitting of these switch disconnectors involves extensive functional tests, since they are moving parts, and these functional tests can therefore be carried out even before transportation. The fact that such moving parts no longer need be fitted and pretested on site, but that this can be done even before transportation, considerably shortens the installation time on site.

In order to allow a small physical height, it is advantageous for the isolating gaps of these switch disconnectors to be at least partially arranged on that side of the boundary plane 2 which faces the circuit breakers. This also contributes to keeping the physical height, that is to say the height of the transport height plane 4, low, as described further above.

The transport unit 10 illustrated in FIG. 3 takes account of these considerations, as described above, in the following manner. The transport container 13 defines an internal volume 12 with a width b and a height h, which do not exceed a width and a height of a standard container. For example, the width b is less than 2.4 m, and the height is less than 2.9 m or even less than 2.6 m. The switch bay in the transport state is accommodated in the transport container 13. The switch bay includes the three gas-insulated circuit breaker modules 110, 210, 310 with the associated circuit breakers, which are arranged parallel to one another. Furthermore, in the transport state, the switch bay includes a switch disconnector module for each of the current phases, with a respective switch disconnector 152, 252, 352 (see FIGS. 2a to 2c) and a busbar module 170, 270 for the first and the second current phases. In addition, in the transport state, the switch bay includes a busbar connection 359 for connection of a third busbar module for the third current phase. This busbar module (module 370 in FIG. 2c) is, however, not connected in the transport state.

Further details and possible modifications of the switch disconnectors 152, 252, 352 will be described below, where such details and modifications can each be used independently of one another and can also be used in further exemplary embodiments than the described embodiment of FIGS. 1-3 (in which case the reference symbols are only illustrative and are not limiting). The switch disconnectors each have a contact element on the circuit breaker side, and this contact element is electrically connected to the respective circuit breaker 112, 212 or 312. Furthermore, the switch disconnectors each have a contact element on the busbar side, which contact element is electrically connected by means of a busbar connection conductor section 156, 256, 356 to the respective busbar phase conductor section or busbar connection 174, 274, as well as 359 and 374.

The contact element which is electrically connected to the circuit breaker is a moving contact element. In the switch disconnector 152, the moving contact element is arranged on that side of the isolating gap 154 which faces away from the circuit breaker. In the switch disconnectors 252, 352, the moving contact element is arranged on that side of the isolating gap 254 or 354, respectively, which faces the circuit breaker. However, other arrangements of the moving contact element are also possible.

The isolating gaps 152, 252, 352 are located between the respective contact elements of the switch disconnectors 150, 250 and 350. This defines an alignment of the respective isolating gap and therefore of the respective switch disconnector as the direction of the contact element on the circuit breaker side toward the contact element on the busbar side. For example, the alignment is defined by the movement direction of a moving contact piece of the switch disconnector. The isolating gaps are arranged parallel to one another, that is to say, these alignments or axes are arranged parallel to one another. This alignment can in turn define the z direction, with the z direction running transversely with respect to the x and y directions. In other words, the respective switch disconnectors 152, 252 and 352 are aligned in the z direction.

The isolating gaps 154, 254, 354 are arranged at least partially on that side of the boundary plane 2 which faces the three circuit breakers 112, 212, 312. In accordance with an exemplary embodiment, the centers of each of the three isolating gaps 154, 254 and 354 are arranged on that side of the boundary plane 2 which faces the three circuit breakers 112, 212, 312. For example, the three isolating gaps (154, 254, 354) are arranged with at least up to 70%, in a number of exemplary embodiments with at least up to 90%, of their length on that side of the boundary plane (2) which faces the three circuit breakers (112, 212, 312).

The first switch disconnector 154 is arranged together with the first busbar phase conductor section 174 in a first busbar module 170. The second switch disconnector 254 is arranged together with the second busbar phase conductor section 274 in a second busbar module 270. The third switch disconnector 354 is arranged together with the busbar connection 359 in a busbar connecting module 350.

A number of other details and possible modifications of the busbar phase conductor sections and of the busbar connection will be described below, where such details and modifications can each be used independently of one another and also in further exemplary embodiments than the exemplary embodiment of FIGS. 1-3 (in which case the reference symbols are only illustrative and not limiting):

The busbar phase conductor sections 174, 274 and if appropriate 374 each have their own housing with their own gas area for each phase. The busbar phase conductor sections 174, 274 and if appropriate 374 are therefore designed for single-phase encapsulation. However, they can have a common gas area for the three phases.

A housing section of the busbar module 170, 270 and/or 370 for the corresponding busbar phase conductor section 174, 274 or 374 is designed to be T-shaped, with the side arms of the T holding the busbar phase conductor section 174, 274 or 374, and with a bottom arm of the T at least partially holding the busbar connection conductor section 156, 256 or 356.

The first (second, third) busbar phase conductor section 174 is offset in the x direction with respect to an axis of the first (second, third) switch disconnector 152. The first and the second busbar phase conductor sections 174, 274 are arranged offset with respect to one another in a z direction, which runs transversely with respect to the x and y directions. The second busbar phase conductor section 274 is arranged at least partially under (that is to say, toward the circuit breakers) the busbar connection for the third current phase 359, in the z direction.

The two (and in a number of exemplary embodiments three) busbar phase conductor sections 174, 274 (and 374) run on a busbar plane 8a which runs in the z and y directions, for example, the two or three busbar phase conductors run on the busbar plane 8a.

The first and second busbar phase conductor sections 174, 274 are separated from one another in the z direction by a busbar module separation, and a position which is intended for a third busbar phase conductor section 374 is separated from the second busbar phase conductor section 274 in the z direction by the busbar module separation. The position of the second busbar phase conductor section 274 has a physical height of less than 230 cm, 250 cm or 270 cm. The position which is intended for the third busbar phase conductor section 374 has a physical height of more than 230 cm, 250 cm or even 270 cm.

The first and second busbar phase conductor sections 174, 274 are arranged at a distance (between centers) d on the busbar plane 8a, and the physical height of the switch bay, for example, of the second busbar phase conductor section 274 and of the busbar connection 359 is less than d away from the boundary plane 2.

The two busbar phase conductor modules 170, 270 have respective busbar flanges 172, 272 for connection of further sections of the busbar phase conductors in the switchgear assembly. The busbar flanges lie at least approximately on a common plane (x-z plane), within an accuracy of 50 cm.

The busbar connection 359 faces away from the circuit breakers 112, 212, 312. The busbar connection 359 faces in a direction other than the y direction. The busbar connection 359, for example, faces in a z direction which runs transversely with respect to the x and y directions, with a discrepancy of 45° or less, for example, of 10° or less.

The busbar connection 359 is arranged outside the busbar phase conductor for the third current phase. The busbar connection is a non-continuous outlet.

The busbar connection has a connecting flange which is oriented in the z direction, with the connecting flange being arranged on a plane which is parallel to the x and y directions. In addition, the busbar connection 359 has a bulkhead insulator. The bulkhead insulator is arranged on a side of the boundary plane 2 which faces away from the circuit breakers, and, in a number of exemplary embodiments, extends parallel to the boundary plane 2. It is also possible to provide a post-type insulator instead of a bulkhead insulator.

The busbar is a double busbar with first busbar phase conductors (with sections 174, 274, 374) and second busbar phase conductors (with sections 194, 294, 394 for the first, second and third current phases, respectively). The switch bay furthermore includes: in each case, one T-like connection piece 140, 240, 340 for the first, second and third current phases, each with a bottom outlet, a first side outlet and a second side outlet which is opposite the first side outlet, wherein each of the three connection pieces 140, 240, 340 can be connected via the respective bottom outlet to the circuit breaker 112, 212, 312, via the respective first side outlet to the first busbar phase conductor section 174, 274, 374, and via the respective second side outlet to the second busbar phase conductor section 194, 294, 394 of the respective current phase.

The first side outlets (e.g., their centers) of all three T-like connection pieces are arranged along a first straight line, and the second side outlets (e.g., their centers) are arranged along a second straight line, with the first (and the second) straight line running along the y direction, in a number of exemplary embodiments.

In a number of exemplary embodiments, each of the three connection pieces has a respective node point, from which electrical conductor sections 145, 146; 245, 246; 345, 346 extend like a star to the respective side outlets and to the respective bottom outlet, and the node points of all three T-like connection pieces run along a third straight line, which runs along the y direction in a number of embodiments.

The switch bay has a first busbar module 170 and a second busbar module 270, with the first busbar phase conductor section 174 being arranged in the first busbar module 170, and the second busbar phase conductor section 274 being arranged in the second busbar module 270. The busbar connection 359 is designed for connection of a third busbar phase conductor section 374 for the third current phase such that a third busbar module 370 of the third current phase can be formed, in which third busbar module 370 the third busbar phase conductor section 374 is arranged.

Furthermore, the switch bay has a third busbar phase conductor section 374 for the third current phase. The third busbar phase conductor section 374 is arranged parallel to the first and to the second busbar phase conductor sections 174, 274, is connected to the busbar connection 359, and/or can be electrically connected to the circuit breaker for the third current phase 312 via the switch disconnector of the third current phase 354.

The third busbar section is offset away from the circuit breakers in a z direction, for example, by the distance d, in comparison to the first and the second busbar sections. In a number of exemplary embodiments, the three busbar phase conductor sections run on the busbar plane 8a, and are separated uniformly from one another.

The busbar phase conductor sections 174, 274 and 374 can in modified exemplary embodiments also be arranged differently than on a planar busbar surface 8a. By way of example, they can, for example, be arranged on a cylinder surface (circle segment in FIG. 8a) or in an L-like configuration, with the sections 174 and 274 being arranged offset essentially in the x direction with respect to one another, and with the section 374 being offset in the z direction with respect to them.

A number of further details and possible modifications of the switch bay will be described below. According to an exemplary embodiment, the switch bay is pretested, that is to say it has already been brought to a state in which it is substantially ready to operate, and is subjected to a number of functional tests in this state. The switch bay is filled with inert gas, for example, at a gas pressure of more than 1 bar, such as at least 1.5 bar. The switch bay is arranged such that it can be transported in a container. The switch bay is designed for an operating voltage of at least 400 kV, for example 420 kV. The switch bay includes three grounding switches, one for each of the three current phases, with the grounding switches being accommodated, for example, in the switch disconnector modules 150, 250, 350, or else with the capability to be accommodated in the connection modules 140, 240, 340. The switch bay includes current transformers and/or voltmeters.

A method for installation of a high-voltage switchgear assembly will be described below. In this case, the installation process also includes those activities such as production, upgrading, repair, etc.

First of all, a preassembled switch bay is provided in a standardized transport container. This is done physically remotely from an installation location for the high-voltage switchgear assembly. For example, the switch bay can be the switch bay shown in FIG. 3, having a first busbar phase conductor section 174 of the first current phase and a second busbar phase conductor section 274 of the second current phase (see also FIGS. 1 to 2c). In the transport state, the switch bay, and in particular the busbar phase conductor sections for the first and the second of the current phases and a busbar connection 359 for the third current phase of the switch bay, has a physical height which is less than the internal height of the transport container. Functional pretesting of the switch bay can optionally be carried out before transportation.

The switch bay is then transported in the transport container to the installation location for the high-voltage switchgear assembly. In a number of embodiments, the switch bay is at least partially filled with inert gas while being transported.

A third busbar phase conductor section of the third current phase is then connected to the busbar connection of the switch bay, as a result of which the busbar phase conductor section of the third current phase has a physical height which is greater than an internal height of the transport container. By way of example, this makes it possible to produce the switch bay illustrated in FIG. 1. In a number of embodiments, the first, second and/or third busbar phase conductor sections are then connected to further sections of the busbar phase conductors in the switchgear assembly. This results in a high-voltage switchgear assembly having a switch bay as described herein.

Optionally, the switch bay can remain in the transport container while being connected, that is to say at least the circuit breakers and the switch disconnectors remain in the transport container.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A switch bay for a high-voltage switchgear assembly, the high-voltage switchgear assembly including a busbar having three busbar phase conductors each respectively provided for a corresponding one of a first current phase, a second current phase and a third current phase, the switch bay comprising:
three gas-insulated circuit breakers each respectively provided for a corresponding one of the first current phase, the second current phase and the third current phase, the circuit breakers being arranged parallel to one another along an x direction;
three switch disconnectors each respectively provided for a corresponding one of the first current phase, the second current phase and the third current phase, the switch disconnectors each having a corresponding isolating gap, respectively, the three isolating gaps being arranged parallel to one another;
a first busbar phase conductor section of the first current phase and a second busbar phase conductor section of the second current phase, the first and the second busbar phase conductor sections extending parallel to one another along a y direction, which runs transversely with respect to the x direction; and
a busbar connection for connection of a third busbar phase conductor section of the third current phase, wherein:
the first and the second busbar phase conductor sections and the busbar connection are configured to be electrically connected via the corresponding switch disconnector of the respective current phase to the circuit breaker of the respective current phase;
the second busbar phase conductor section defines a boundary plane which runs in the x and y directions and contains a center of the second busbar phase conductor section;
each of the three isolating gaps is arranged at least partially on a side of the boundary plane which faces the three circuit breakers; and
the first busbar phase conductor section, the second busbar phase conductor section and the third busbar phase conductor section are arranged one above the other in a z direction, which runs transversely with respect to the x and y directions, after connection of the third busbar phase conductor section of the third current phase to the busbar connection of the switch bay.

2. The switch bay as claimed in claim 1, wherein the three isolating gaps are arranged with at least up to 70% of their length on the side of the boundary plane which faces the three circuit breakers.

3. The switch bay as claimed in claim 1, wherein the isolating gaps are arranged parallel to one another in the z direction.

4. The switch bay as claimed in claim 1, wherein the busbar connection faces in the z direction.

5. The switch bay as claimed in claim 1, wherein:
the busbar connection includes a bulkhead insulator, which is arranged on a side of the boundary plane which faces away from the circuit breakers.

6. The switch bay as claimed in claim 1, wherein the first and the second busbar phase conductor sections are arranged offset with respect to one another in the z direction.

7. The switch bay as claimed in claim 6, wherein the first and second busbar phase conductor sections run on a busbar plane which runs in the z and y directions.

8. The switch bay as claimed in claim 1, wherein at least two of the x, y and z directions run at right angles to one another.

9. The switch bay as claimed in claim 1, wherein the busbar is a double busbar, the busbar phase conductors are first busbar phase conductors, and the double busbar in each case includes a second busbar phase conductor of the first, second and third current phases,
wherein the switch bay comprises:
three T-like connection pieces each provided for a corresponding one of the first, second and third current phases, the three T-like connection pieces each being respectively provided with a bottom outlet, a first side outlet and a second side outlet opposite the first side outlet,
wherein each of the three connection pieces are configured to be connected via the respective bottom outlet to the circuit breaker, via the respective first side outlet to the first busbar phase conductor, and via the respective second side outlet to the second busbar phase conductor of the respective current phase, and
the first side outlets of all three T-like connection pieces are arranged along a first straight line.

10. The switch bay as claimed in claim 1, comprising:
a first busbar module and a second busbar module,
wherein the first busbar phase conductor section is arranged in the first busbar module, and the second busbar phase conductor section is arranged in the second busbar module, and
wherein the busbar connection is configured for connection of a third busbar phase conductor section of the third current phase such that a third busbar module of the third current phase can be formed, in which third busbar module the third busbar phase conductor section is arranged.

11. The switch bay as claimed in claim 10, wherein the switch disconnector of the first current phase is arranged in the first busbar module, the switch disconnector of the second current phase is arranged in the second busbar module, and the switch disconnector of the third current phase is arranged together with the busbar connection in a busbar connecting module.

12. The switch bay as claimed in claim 1, wherein the switch disconnector of the first current phase and the switch disconnector of the second current phase are aligned in opposite senses with respect to one another.

13. The switch bay as claimed in claim 1, comprising:
a drive system for operation of the switch disconnectors and of the circuit breakers,
wherein the drive module is connected to the switch disconnectors and to the circuit breakers such that they are ready to operate.

14. The switch bay as claimed in claim 1, wherein the switch bay is preassembled to be ready for transport, and its dimensions are such that the switch bay is located in a standardized transport container having a physical height of less than 270 cm.

15. The switch bay as claimed in claim 1, wherein the busbar connection has no busbar phase conductor section connected to it.

16. The switch bay as claimed in claim 1, comprising:
a third busbar phase conductor section for the third current phase,
wherein the third busbar phase conductor section is arranged parallel to the first and to the second busbar phase conductor sections, is connected to the busbar connection, and is configured to be connected to the circuit breaker of the third current phase via the switch disconnector of the third current phase.

17. The switch bay as claimed in claim 16, wherein the third busbar phase conductor section is removably connected to the busbar connection, and has a physical height of more than 270 cm.

18. A high-voltage switchgear assembly having a switch bay as claimed in claim 1.

19. The switch bay as claimed in claim 8, wherein all three of the x, y and z directions run at right angles to one another.

20. The switch bay as claimed in claim 5, wherein the busbar is a double busbar, the busbar phase conductors are first busbar phase conductors, and the double busbar in each case includes a second busbar phase conductor of the first, second and third current phases,
wherein the switch bay comprises:
three T-like connection pieces each provided for a corresponding one of the first, second and third current phases, the three T-like connection pieces each being respectively provided with a bottom outlet, a first side outlet and a second side outlet opposite the first side outlet,
wherein each of the three connection pieces are configured to be connected via the respective bottom outlet to the circuit breaker, via the respective first side outlet to the first busbar phase conductor, and via the respective second side outlet to the second busbar phase conductor of the respective current phase, and
the first side outlets of all three T-like connection pieces are arranged along a first straight line running along the y direction.

21. A high-voltage switchgear assembly having a switch bay as claimed in claim 20.

22. The switch bay as claimed in claim 9, wherein the first straight line runs along the y direction.

23. A method for installation of a high-voltage switchgear assembly, the method comprising:
providing a preassembled switch bay according to the switch bay as claimed in claim 1 in a standardized transport container physically remotely from an installation location for the high-voltage switchgear assembly, wherein the switch bay has the first busbar phase conductor section of the first current phase and the second busbar phase conductor section of the second current phase;
transporting the switch bay in the transport container to the installation location for the high-voltage switchgear assembly; and
connecting a third busbar phase conductor section of the third current phase to a busbar connection of the switch bay, such that the busbar phase conductor section of the third current phase has a physical height which is greater than an internal height of the transport container.

24. The method as claimed in claim 23, comprising:
functionally pretesting the switch bay before transportation.

25. The method as claimed in claim 23, wherein the switch bay remains in the transport container during the connection of the third busbar phase conductor section.
